(19) United States
(12) Patent Application Publication
(10) Pub. No.: US 2015/0045707 A1
(43) Pub. Date: Feb. 12, 2015

(54) MASSAGING ROLLER

(71) Applicant: Brandon Selvaggio, Kirkland, OH (US)

(72) Inventor: Brandon Selvaggio, Kirkland, OH (US)

(21) Appl. No.: 14/450,500

(22) Filed: Aug. 4, 2014

Related U.S. Application Data
(60) Provisional application No. 61/863,180, filed on Aug. 7, 2013.

(51) Int. Cl. A61H 15/00

(52) U.S. Cl. CPC A61H 15/00; A61H 2201/1671
USPC 601/118

(57) ABSTRACT

A massaging roller has a first member forming a relatively rigid inner core and a second member forming a less rigid sleeve mounted on the inner core. The sleeve forms a working surface including a plurality of spaced ribs and grooves which extend longitudinally along an axis of the sleeve. The ribs and grooves are configured to provide spinal decompression and massaging therapy to the user.

### CLAIM OF PRIORITY

This application claims priority to Provisional Patent Application Ser. No. 61/863,180 filed on Aug. 7, 2013, which is hereby incorporated by reference in its entirety.

### BACKGROUND OF THE DISCLOSURE

The present disclosure pertains to a massaging roller and, more generally, to a manually applied device for dealing with back or neck disorders or muscle soreness and for providing massages for one's back or neck or for one's muscles.

One common cause of backaches in today's population is that people generally have sedentary occupations. Some types of employment require a person to sit for most of an eight hour working day, with little time available for exercise. Other employment requires significant use of one's back muscles resulting in tired and stiff muscles and vertebral misalignment.

A backache is a common syndrome characterized by pain and tenderness emanating from components of a person's spinal support system. The pain is experienced deep under the skin and is typically not localized. It is characteristically of a dull and aching quality. The pain is almost always associated with mechanical dysfunction of neuromuscular tissues. Progressive pain syndrome has a deleterious effect on the spinal support system and the person to whom the painful back belongs. This results in inhibition of the spinal extensor muscles, or, if very painful, a co-contraction of the flexor and extensor trunk muscles, resulting in muscle spasms.

When the symptoms become severe, an individual's only recourse is to seek medical attention. However, by that time, muscles may have atrophied or a person's posture may have suffered to compensate for painful sections of the spine. Furthermore, a patient may require extensive remedial action to recover from his or her pain. While there are many proposed methods and products for relieving back pain, some of the products available require significant financial investment and are not portable. Others could be perceived as a possible cause of additional pain because of their construction. For example, some products are made of metal with knobs, knurls, sharp edges, etc. Other products are large devices meant for traction or manipulation of the spine. Further, some products are meant to be used along a longitudinal axis parallel to the spine, rather than in a transverse direction perpendicular to the spine.

Many implements for back therapy and massage have been developed and used, including powered vibrating implements with rounded knobs and unpowered tools having rounded knobs and studded rollers. Typically, such implements are either designed to be used on a person receiving the therapy or massage by a second person providing same, or are designed to be applied to a particular portion of the body, such as a foot, by a single person providing their own therapy.

It would be advantageous to provide a massaging device which an individual can use in the privacy of their home or office, without the need for visiting a doctor, while either lying supine on a firm surface or standing and pressing against a vertical surface or wall. This would enable a person to give himself or herself either a complete back or muscle massage or therapy for one's spine in order to relieve back pain or one's neck to relieve neck pain.

### BRIEF SUMMARY OF THE DISCLOSURE

The present disclosure relates to a massaging roller which can be employed for therapeutic uses, such as a spinal adjustment of the user or for muscle massage purposes. It includes a body comprising a relatively rigid tube, and a relatively flexible sleeve mounted on the tube. The sleeve includes an outer face comprising a plurality of spaced grooves and ridges which extend longitudinally along an axis of the tube.

In accordance with one aspect of the disclosure, a massaging roller includes a first member forming a rigid inner core and a second member forming a less rigid sleeve mounted on the inner core. The sleeve forms a working surface and includes a plurality of spaced ribs and grooves which extend longitudinally along an axis of the sleeve. The ribs and grooves are configured to provide massaging therapy to the user.

In accordance with another aspect of the disclosure, a massaging roller for promoting spinal decompression and tissue massage in a user includes a first body forming a core formed of a first material and a second body forming a sleeve formed of a second material. The sleeve is mounted on the core. The first material is relatively hard in comparison to the second material, and the second material is relatively flexible in comparison to the first material. The second body includes a work surface comprising ridges separated by grooves and the work surface is configured to promote spinal decompression and tissue massage in the user.

In accordance with still another aspect of the disclosure, a massaging roller for providing massage therapy to a user includes a first body comprising an elongated tube having a first longitudinal axis and a second body forming an elongated sleeve having a second longitudinal axis. The second body is mounted on the first body so that the second axis is coaxial with the first axis. The second body includes a work surface comprising ribs separated by grooves adapted to provide massage therapy to a user's body.

Yet another aspect of the disclosure is that the spacing between ribs and the rib width and thickness are specifically designed to promote spinal disc decompression along with deep tissue massage.

Another aspect of the disclosure is providing spinal disc decompression or vertebrae alignment benefits through the ribbed feature of the present disclosure.

Still another aspect of the disclosure is the use of a durable and rigid PVC core in comparison to foam or other existing types of cores. The thickness of the PVC core allows for structural integrity when used by heavier people. The firmness of the core also allows for a consistent experience regardless of the size of the user.

Still another aspect of the disclosure is the provision of an elongated work surface of the roller having a width configured to provide massage therapy to a user. For example, the roller can be employed to massage a back of the user.

Yet another aspect of the disclosure is the provision of end caps which may be of a different color from the roller to differentiate the caps from the roller. The caps may also have knurled surfaces which serve as handles or gripping surfaces for carrying or moving the roller during use.

Still other aspects of the disclosure will become apparent upon a reading and understanding of the following detailed description.

### BRIEF DESCRIPTION OF THE DRAWINGS

The present disclosure may take form in various components and arrangements of components and in various steps and arrangements of steps. The drawings are only for purposes of illustrating several embodiments of the disclosure and are not to be construed as limiting same. The disclosure is illustrated in the accompanying drawings which form a part hereof an wherein:

FIG. 1 is a front elevational view of a massaging roller according to one embodiment of the present disclosure;

FIG. 2 is an end elevational view thereof, with certain portions removed for clarity;

FIG. 3 is an enlarged schematic view of the massaging roller of FIG. 2;

FIG. 4 is a schematic view of a massaging roller according to another embodiment of the present disclosure;

FIG. 5 is a view of a human vertebrae; and

FIG. 6 is a schematic perspective view of a user lying in a horizontal position employing the massaging roller according to the present disclosure.

### DETAILED DESCRIPTION OF THE DISCLOSURE

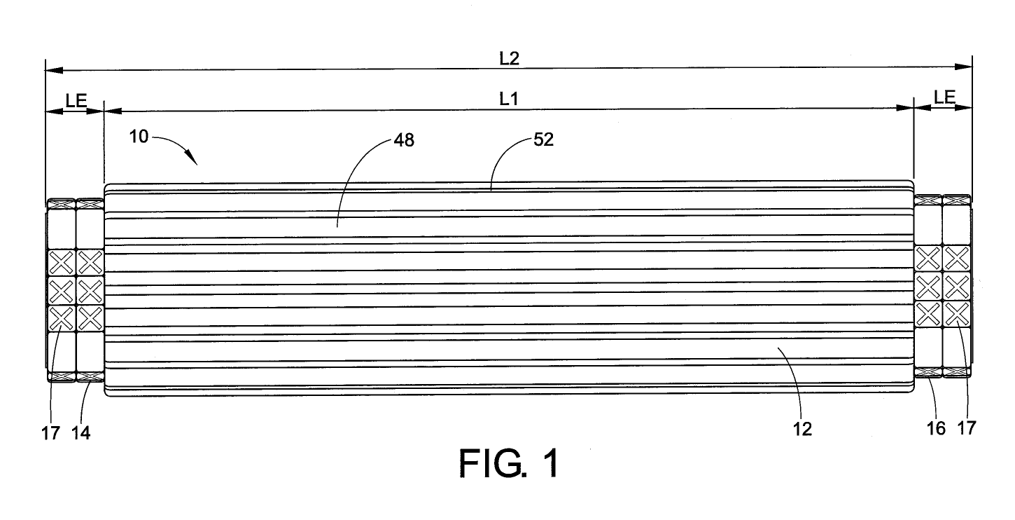

Referring now to the drawings wherein the showings are for purposes of illustrating embodiments of the present disclosure and not for purposes of limiting same, FIG. 1 illustrates an embodiment of a massaging roller in accordance with one aspect of the disclosure, which can be used on a person's back or neck or another area of the person's body. Specifically, the roller includes an elongated body 10 having an outer working surface 12, as well as a first distal end 14 and a second opposite distal end 16. The ends can be configured so that they can be used as handles. Ends 14 and 16 can have knurled or gripping surfaces 17 to facilitate holding and moving the roller between uses. The ends may be formed as end caps which may be of a different color from the roller to differentiate the caps from the roller.

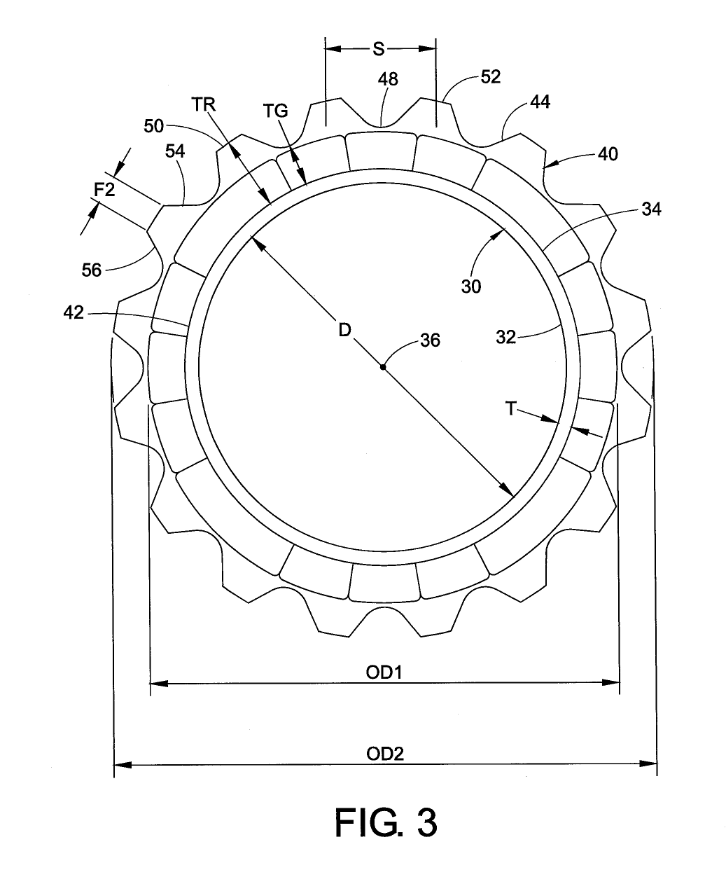

With reference now to FIG. 3, the body includes an elongated tube 30 having an inner face 32 and an outer face 34. The tube also has a longitudinal axis 36 (extending out of the pipe in FIG. 3). In one embodiment, the tube 30 can be made from a thermoplastic material such as a PVC pipe or a like relatively rigid material, as is well known in the art. The PVC pipe forms a durable and rigid core. In contrast, existing rollers have a foam or other less rigid material type of core. The thickness of the PVC core allows the massaging roller to retain its structural integrity when used by heavier people. The firmness of the core also allows for a consistent experience regardless of the size of the user. In one embodiment, the tube can have a thickness T of about 0.125 inches (i.e., ⅛ of an inch) and can have an internal diameter D of about 4 inches. Other dimensions are also contemplated by the disclosure.

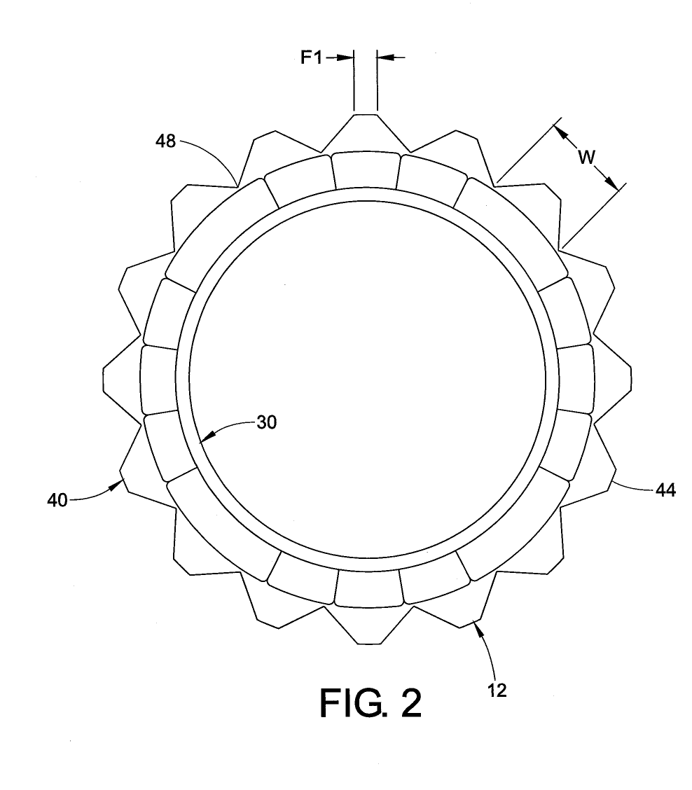

As seen in FIG. 3, mounted on the tube is an outer sleeve 40. The sleeve includes an inner face 42 which abuts the outer face 34 of the tube. As shown in FIG. 2, an outer face 44 of the sleeve comprises the working surface 12 of the massaging roller shown in FIG. 1. The sleeve 40 which can be slipped over the tube can be secured thereto via conventional means, such as by an adhesive material. The sleeve can be made from a foam type thermoplastic or similar relatively resilient material which is generally softer and less rigid than the material (e.g., PVC) from which the tube is made. In an alternative embodiment, the tube and sleeve can be coextruded from dissimilar thermoplastic materials, in order to provide a relatively rigid core which provides a uniform experience regardless of the weight of the user and a relatively flexible working surface for the massaging roller. The tube is sufficiently rigid to provide a core which can withstand pressure created by a heavy user, while the sleeve is sufficiently flexible and soft enough so as to not harm or pinch the user while the user is pressing against the sleeve.

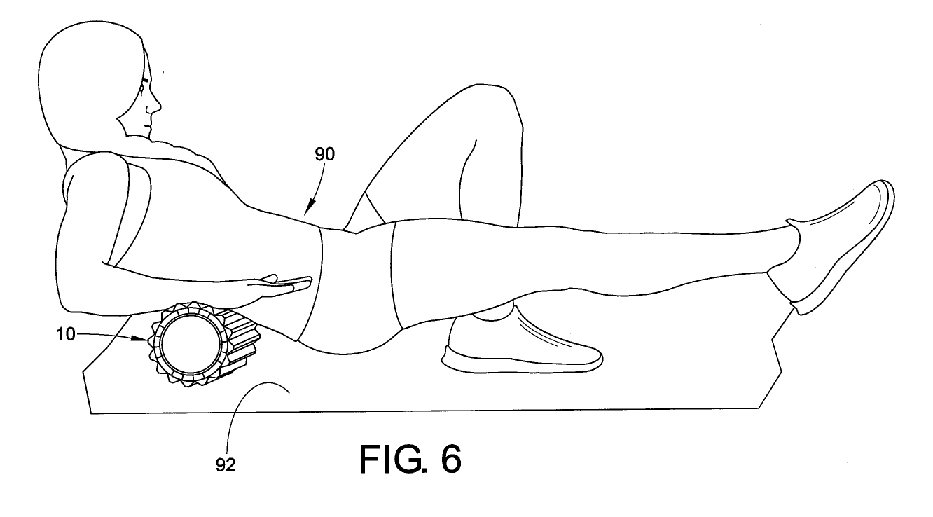

The working surface of the massaging roller includes spaced apart grooves 48 which are formed between spaced apart ridges 50. The ridges can be spaced apart by a distance S of about 1.25 inches (measured between centerlines of adjacent ridges). Grooves 48 may be formed as angled grooves such as shown in FIG. 2, or as rounded or curved grooves as shown in FIG. 3. It should be appreciated that a generally gear-like working surface 12 is provided on the roller. As is evident from FIG. 1, the ribs or ridges can extend along the entire length of the roller, in an orientation generally parallel to the longitudinal axis 36 of the tube. The ridges also can extend along the entire outer perimeter of the roller. Thus, a gear-like surface is presented, as shown in FIGS. 2 and 3. In one embodiment, as illustrated in FIG. 1, the working length L1 of the massaging roller can be on the order of 21 inches. The working length L1 of the roller is significant so as to provide an elongated surface to contact a full width of the user's body (see FIG. 6) and provide massage therapy. The overall length L2 of the roller can be about 24 inches. The lengths LE of the ends 14, 16 can each be about 1.5 inches. Each ridge in this embodiment is further defined by a flat outer face 52 and flat (FIG. 2) or somewhat curved (FIG. 3) first and second opposite shoulders 54 and 56 which in turn lead to adjacent angled or rounded grooves 48.

In one embodiment, the material of the sleeve 40 can have a thickness TG of approximately 0.375 inches (i.e., ⅜ of an inch) defined by the grooves and a thickness TR of 0.75 inches (i.e., ¾ of an inch) defined at the flat face 52 of the ridge, both being measured from the inner face 42 of the sleeve 40. Thus, the depth of each groove can be about 0.375 inches (i.e., ⅜ of an inch or TR-TG) and the thickness or height of the ridges or ribs is about 0.375 inches.

The width F1 (FIG. 2) or F2 (FIG. 3) of a flat face 52 on the rib can be about 0.25 inches (i.e., ¼ of an inch). The overall width W (or length) of the rib is about 0.75 inches (measured at the base of the ridge between adjacent grooves). In the disclosed embodiment, the spacing S between the ridges 50 can be about 1.25 inches. It has been found that this spacing is most effective to treat the spine of a man of average size. Perhaps for a woman of average size, a ridge spacing S of 1.125 inches would work best. Thus, it should be appreciated that the rib spacing on the massaging roller can be varied (such as between 1.125 and 1.25 inches) as may be desirable for a body of a particular size.

The spacing (e.g., 1.25 inches) between the ribs or ridges and the rib or ridge height or thickness (e.g., 0.375 inches) as well as the ridge rib width W (e.g., 0.75 inches) are specifically designed to promote spinal disc decompression along with deep tissue massage. Existing massage devices may offer massaging and core strengthening benefits but not spinal disc decompression or vertebrae alignment benefits by providing the ribbed feature of the present disclosure.

It should be appreciated that sleeves having other designs could be employed in addition to the sleeve 40 illustrated in the instant drawings. Thus, those skilled in the art will understand that various modifications of the massaging roller can be made without departing from the scope of the instant disclosure. In one embodiment, the hardness of the sleeve 40 or at least the working surface 12 can be about 54 measured on the Shore A scale. In the embodiment illustrated, the outer diameter OD1 of the sleeve is 4.75 inches and the outer diameter OD2 of the roller, i.e., from rib to rib is 5.5 inches. However, rollers of other diameters are also contemplated by the disclosure.

In one embodiment, the tube 30 can comprise a polyvinylchloride (PVC) material which can have a Rockell hardness of about 115 and a Shore D durometer of about 89. Further, the outer sleeve 40 can comprise a polyurethane material which can have a Shore A durometer of between 40 and 80. Rubber could be an alternative material. Thus, a variety of hardness can be provided for the sleeve 40 which can range to either side of the hardness of, for example, a car tire tread (Shore A hardness of 60), depending on what hardness is considered optimum by a user. It should be recognized that other known types of materials could also be used to form the tube 30 and outer sleeve 40. For example, a dual durometer sleeve could be employed wherein the flat face 52 and a portion of the ridge 50 part way down the shoulders 54 and 56 can be of a first durometer and the remainder of the sleeve can be of a second, different, durometer. In other words, the sleeve could be made of a coextruded material.

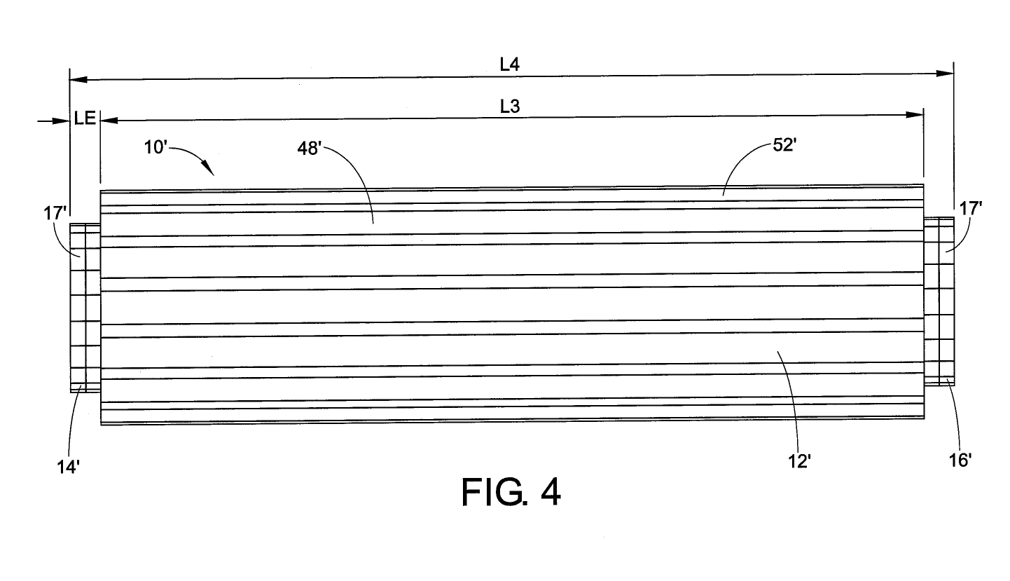

In another embodiment, as illustrated in FIG. 4, the entire length L4 of a massaging roller 10′ can be 21 inches. Each end 14′ and 16′ of the massaging roller 10′ can have a length LE on the order of 1.52 inches. The roller 10′ also includes a working surface 12′ with a plurality of longitudinally extending ribs 52′ separated from each other by grooves 48′. Thus, in the embodiment illustrated in FIG. 4, the total length L4 of the roller is 21 inches and the working length L3 of the roller would be 18 inches. In the embodiment illustrated in FIG. 1 on the other hand, the total length L2 of the massaging roller can be about 24 inches, and its working length L1 can be 21 inches. Other lengths are also contemplated by the disclosure.

While continuous ridges 50 are illustrated in FIGS. 1 and 4, it should be appreciated that in certain embodiments of the massaging roller, interrupted ridges could be employed. Further, it is also contemplated that some of the ridges of the roller can be continuous while others are interrupted. For example, every other ridge around the circumference of the roller could be continuous if so desired.

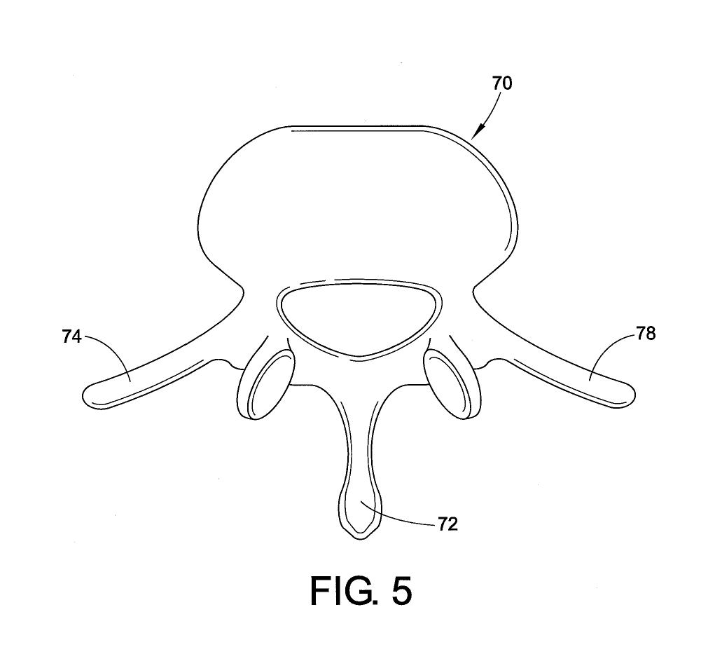

With reference now to FIG. 5, a human vertebrae 70 is shown illustrating a spineous process 72, as well as a left transverse process 74 and a right transverse process 78. An adjustment of the vertebrae in a person's back is possible due to the nature of the massaging roller, as it puts pressure on the vertebrae when (as shown in FIG. 6) a user 90 lies in a supine position on a ground surface or floor 92 and employs the roller beneath the user and between a back of the user and the floor. Alternatively, the roller could be trapped between a wall and a user's back when the user is standing and be employed in that fashion. The massaging roller can be oriented transverse to a longitudinal axis of the user. As the user rolls or moves back and forth over the roller, the roller allows fluid to flow into the area between the discs and spreads the vertebrae 70, thereby bringing relief to a sore back of the user. Alternatively, the roller can also be used for massage purposes to massage a person's back muscles. It should also be appreciated that the user could also employ the roller to massage one's arm or leg or other muscle areas.

Further, it should be recognized that the massaging roller could be employed at an angle other than transverse to the longitudinal axis of the user, if so desired.

With the outer faces of the ribs 52, 52′ being spaced as they are in the disclosed embodiment, generally at 1.25 inches apart, the ribs allow for back therapy or massage with pressure applied at particular points along the back of a user.

Referring again to FIG. 6, the massaging roller 10 can be used for massaging one's upper back by rolling slowly from the lower edge of a person's trapezius muscles to the top of the rhomboids. The roller can also be used for spinal disc decompression, vertebrae alignment, direct myofascial release or deep tissue massage.

In addition, the roller can be used to massage the hamstring muscles, calf muscles, quadriceps muscles, the latissimus muscle or the illiotibial tract. The user can pause at any spot which feels especially tender. A user can dig down deeper into the muscle to increase the intensity of the muscle massage if the user so desires. FIG. 6 illustrates one view of the massaging roller being employed to massage a user's back while the user 90 is in a horizontal (lying) position such that the user's back is oriented parallel to floor of surface 92.

In another embodiment, the massaging roller can be provided on an axle mounted via bearings at each end to respective handles so that the body of the massaging roller is separated by the bearings from the handles of the device in order that the body can be rotated in relation to the handles. In this embodiment, the user could grasp the roller by its handles, dispose it behind their back and apply the roller to their back or neck or to one or more muscles, such as while sitting on a stool. The handles at the first and second ends of the body makes such manipulation by users easier to accomplish.

The present disclosure pertains to a massaging roller which can be employed by an individual anywhere there is sufficient floor space or access to a vertical surface that can withstand the pressure applied against the device. The device applies pressure concurrently to a limited number of vertebrae of a user's back or neck, depending on the circumference of the roller.

The disclosure has been described with reference to several embodiments. It should be appreciated that the present disclosure can be modified in a number of ways as is known to those of ordinary skill in the art. Therefore, this disclosure is intended to cover any variations, uses or adaptations which fall within known or customary practices in the art. Obviously, modifications and alterations will occur to others upon a reading and understanding of this specification. It is intended to include all such modifications and alterations insofar as they come within the scope of the appended claims or the equivalents thereof.

What is claimed is:

1. A massaging roller comprising:
a first member forming an inner core;
a second member forming a sleeve mounted on said inner core, wherein said sleeve is less rigid than said inner core, wherein said sleeve forms a working surface comprising a plurality of spaced ribs and grooves which extend longitudinally along an axis of said sleeve, wherein said ribs and grooves are configured to provide massaging therapy to a user.

2. The massaging roller of claim 1, wherein said first member comprises a tube made of PVC material.

3. The massaging roller of claim 2, wherein said sleeve is formed of a foam material wherein said foam material is less rigid than said PVC material of said tube.

4. The massaging roller of claim 1, wherein said second member further comprises a first end and a second end, wherein at least one of said first and said second ends forms a handle.

5. The massaging roller of claim 1, further comprising a first end member and a second end member located on opposite ends of said first member, wherein each of said first and second end members forms a handle.

6. The massaging roller of claim 1, wherein said second member comprises an inner face which abuts an outer face of said first member.

7. The massaging roller of claim 1, wherein said ribs are spaced approximately 1.125 to 1.25 inches apart.

8. The massaging roller of claim 7, wherein said ribs are approximately 0.375 inches in height.

9. The massaging roller of claim 8, wherein said ribs are configured to promote spinal decompression in the user.

10. The massaging roller of claim 1, wherein said first member has a Shore D hardness of about 115 and wherein said second member has a Shore A hardness between about 40 and about 80.

11. The massaging roller of claim 10, wherein said first member comprises a PVC material and said second member comprises one of a polyurethane or a rubber material.

12. A massaging roller for promoting spinal decompression and tissue massage in a user, comprising:
a first body forming a core formed of a first material, a second body forming a sleeve formed of a second material, said sleeve being mounted on said core, wherein said first material is relatively hard in comparison to said second material, and said second material is relatively flexible in comparison to said first material and wherein said second body comprises a work surface comprising ridges separated by grooves, wherein said work surface is configured to promote spinal decompression and tissue massage in the user.

13. The massaging roller of claim 12, wherein said first body comprises a PVC material and said second body comprises a polyurethane material.

14. The massaging roller of claim 13, wherein said first body has a Shore D hardness of about 115 and wherein said second body has a Shore A hardness of between about 40 and about 80.

15. The massaging roller of claim 12, wherein outer faces of said ridges each comprise a flat top surface.

16. The massaging roller of claim 15, wherein said outer faces are spaced approximately 1.125 to 1.25 inches apart and said ridges are approximately 0.375 inches in height.

17. The massaging roller of claim 12, wherein said second body includes a longitudinal axis and wherein said ridges extend parallel to said longitudinal axis.

18. A massaging roller for providing massage therapy to a user, comprising:
a first body comprising an elongated tube having a first longitudinal axis;
a second body forming an elongated sleeve having a second longitudinal axis, wherein said second body is mounted on said first body so that said second axis is coaxial with said first axis, wherein said second body includes a work surface comprising ribs separated by grooves adapted to provide massage therapy to a user's body.

19. The massaging roller of claim 18, wherein said first body is formed of a first material and said second body is formed of a second material wherein said first material is more rigid than said second material and said second material is more flexible than said first material.

20. The massaging roller of claim 18, wherein said ribs and grooves of the work surface extend in a direction parallel to said second longitudinal axis.
